(19) United States
(12) Patent Application Publication
(10) Pub. No.: US 2026/0152657 A1
(43) Pub. Date: Jun. 4, 2026

(54) COATING MATERIAL AND OIL-PROOF PAPER

(71) Applicant: Sustainable Carbohydrate Innovation Co., Ltd., Taipei City (TW)

(72) Inventors: Ya-hui HUANG, Taipei City (TW); Yu-chien KAO, Taipei City (TW)

(73) Assignee: Sustainable Carbohydrate Innovation Co., Ltd., Taipei City (TW)

(21) Appl. No.: 19/005,469

(22) Filed: Dec. 30, 2024

(30) Foreign Application Priority Data
Dec. 3, 2024 (TW) 113146727

(51) Int. Cl. C09D 101/28; C09D 103/04; D21H 17/17; D21H 19/12; D21H 19/22; D21H 19/34; D21H 27/28

(52) U.S. Cl. CPC C09D 101/286; C09D 103/04; D21H 17/17; D21H 19/12; D21H 19/22; D21H 19/34; D21H 27/28

(57) ABSTRACT

A coating material includes silane salt-modified polysaccharide salt, cationic starch, and water. The silane salt can be Si(OH)ₓ(OK)_{y}(R)_{4-x-y}; R is a C₁₋₁₀ alkyl group; x=1 to 2, y=1 to 2, and x+y=2 to 3. The polysaccharide salt is a salt of cellulose derivative, natural gum, alginic acid, starch, chitosan, or a combination thereof. The coating material can be used to manufacture an oil-proof paper.

### CROSS REFERENCE TO RELATED APPLICATIONS

The present application is based on, and claims priority from, Taiwan Application Serial Number 113146727, filed on Dec. 3, 2024, the disclosure of which is hereby incorporated by reference herein in its entirety.

### TECHNICAL FIELD

The technical field relates to an oil-proof paper, and in particular it relates to a composition of a coating layer for the oil-proof paper.

### BACKGROUND

Oil-proof paper can be manufactured according to contents of Taiwan Patent No. TWI424121. The surface tension of the paper base can be reduced by coating fluorocarbon compound resin on the paper base, so that the paper base has a moderate ability to repel oil, thereby achieving oil resistance or oil-proofing of the surface of the paper base.

However, the fluorocarbon compound resin tends to release perfluoroalkyl compounds during decay. Perfluoroalkyl compounds such as perfluorooctane sulfonate (PFOS), perfluorooctanoic acid (PFOA), and the like are necessary to serve as an auxiliary agent during the manufacturing of fluorocarbon compound resin. The perfluoroalkyl compounds have proven to be harmful to the human body, and have been included in the banned or watch lists of developed countries such as the United States and those in the European Union.

Another method of manufacturing conventional oil-proof paper is mainly to attach PE plastic thin film or metal foil (e.g., aluminum foil) onto a paper base to obtain a composite material. The oil-proof paper formed of the composite material has high oil resistance, excellent water-proof properties, and excellent gas barrier properties.

Although the oil-proof paper formed of the composite material has high oil resistance, the plastic material has an insufficient resistance to temperature. The plastic material tends to release toxic substances such as plasticizer at high temperature. In particular, the oil-proof paper is usually contact with food at high temperature when the oil-proof paper is used to serve food. In addition, the user often puts the oil-proof paper serving food into a microwave oven to heat the food, and the user unconsciously ingests the harmful substances.

Accordingly, a novel oil-proof paper is called for to address the above issues.

### SUMMARY

One embodiment of the disclosure provides a coating material, including silane salt-modified polysaccharide salt; cationic starch; and water.

In some embodiments, the silane salt is Si(OH)ₓ(OK)_{y}(R)_{4-x-y}, wherein R is a C₁₋₁₀ alkyl group, x=1 to 2, y=1 to 2, and x+y=2 to 3.

In some embodiments, the polysaccharide salt is a salt of cellulose derivative, natural gum, alginic acid, starch, chitosan, or a combination thereof.

In some embodiments, the polysaccharide salt and the silane salt have a weight ratio of 55:45 to 95:5.

In some embodiments, the silane salt-modified polysaccharide salt and the cationic starch have a weight ratio of 30:70 to 70:30.

In some embodiments, the coating material further includes a water-proofing agent, and the water-proofing agent is alkyl keten dimer, styrene acrylate emulsion, or a combination thereof.

In some embodiments, the total weight of the silane salt-modified polysaccharide salt and the cationic starch and the weight of the water-proofing agent have a ratio of 100:1 to 100:20.

In some embodiments, the coating material is free of fluorine.

One embodiment of the disclosure provides an oil-proof paper, including a paper-based substrate; and a coating layer covering the paper-based substrate, wherein the coating layer includes silane salt-modified polysaccharide salt; and cationic starch.

In some embodiments, the coating layer further includes a water-poof agent, and the water-proofing agent is alkyl keten dimer, styrene acrylate emulsion, or a combination thereof.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a coating material, including silane salt-modified polysaccharide salt; cationic starch; and water. In some embodiments, the silane salt is Si(OH)ₓ(OK)_{y}(R)_{4-x-y}, wherein R is a C₁₋₁₀ alkyl group, x=1 to 2, y=1 to 2, and x+y=2 to 3. For example, the silane salt can be potassium methylsiliconate (PMS) having a chemical structure of

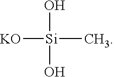

It should be understood that the silane salt can be another usual silane salt and is not limited to PMS. The described coating material has a solid content of about 5% to 30%. If the solid content is too low, the subsequent step such as baking drying the coating material to form a coating layer will cost too much time and energy. If the solid content is too high, it will be difficult to evenly mix the silane salt-modified polysaccharide salt and the cationic starch, and precipitate will be easily formed. In addition, the matrix of the coating material is water, antibacterial agent and/or antifungal agent can be optionally added to prevent the growth of mold or bacteria in the coating material.

In some embodiments, the polysaccharide salt is a salt of polysaccharide such as cellulose derivative (e.g., cellulose ether, methylcellulose, hydroxyethylcellulose, carboxymethylcellulose, or hydroxypropylmethylcellulose), natural gum (e.g., xanthan gum or carrageenan), alginic acid, starch, chitosan, or a combination thereof. The salt can be sodium salt, potassium salt, ammonium salt, a combination thereof, or the like. For example, the polysaccharide salt can be sodium carboxymethyl cellulose.

The so-called cationic starch is starch having terminals modified by ammonium ions, sodium ions, potassium ions, a combination thereof, or the like.

In one embodiment, the polysaccharide salt and the silane salt are dissolved in water and then heated to reflux, such that the hydroxy group of the polysaccharide salt and the silanol group of the silanol salt undergo a dehydration reaction to form a bonding, thereby obtaining silane salt-modified polysaccharide salt. In some embodiments, the polysaccharide salt and the silane salt have a weight ratio of 55:45 to 95:5. If the amount of the silane salt is too low, the oil-proof paper formed from the coating material will have an insufficient oil-proof properties. If the amount of the silane salt is too high, the solid suspension in the coating material will be too much to process.

In some embodiments, the silane salt-modified polysaccharide salt and the cationic starch have a weight ratio of 30:70 to 70:30. If the amount of the cationic starch is too low or too high, the oil-proof paper formed from the coating material will have water absorbability that is too high.

In some embodiments, the coating material further includes a water-proofing agent, and the water-proofing agent is alkyl keten dimer, styrene acrylate emulsion, or a combination thereof. The water-proofing agent may further reduce the water absorbability of the oil-proof paper.

In some embodiments, the total weight of the silane salt-modified polysaccharide salt and the cationic starch and the weight of the water-proofing agent have a ratio of 100:1 to 100:20. If the amount of the water-proofing agent is too low, the effect of the coating material will be similar to the effect of the coating material without the water-proofing agent, and the water absorbability of the oil-proof paper formed from the coating material cannot be further reduced. If the amount of the water-proofing agent is too high, the oil-proof paper formed from the coating material will have insufficient oil-proof properties.

In some embodiments, the coating material is free of fluorine to prevent the fluorine from damaging the user's health.

One embodiment of the disclosure provides an oil-proof paper, including a paper-based substrate; and a coating layer covering the paper-based substrate, wherein the coating layer includes silane salt-modified polysaccharide salt; and cationic starch. For example, the coating material can be coated on the paper-based substrate, and then baked dry to remove water in the coating material to form a coating layer on the paper-based substrate. In some embodiments, the paper-based substrate can be paper. Alternatively, the paper-based substrate can be mixed with another material such as cotton, or even a little amount of plastic, metal, ceramic, or the like, as long as the weight ratio of paper is greater than 90%.

In some embodiments, the coating layer further includes a water-proofing agent, and the water-proofing agent is alkyl keten dimer, styrene acrylate emulsion, or a combination thereof. The types and ratios of the silane salt, the polysaccharide salt, the cationic starch, and the water-proofing agent are similar to those described above, and the related description is omitted here.

Below, exemplary embodiments will be described in detail with reference to accompanying drawings so as to be easily realized by a person having ordinary knowledge in the art. The inventive concept may be embodied in various forms without being limited to the exemplary embodiments set forth herein.

### EXAMPLES

In following Examples, the paper-based substrate for the oil-proof paper was A4 printing paper (80 gsm) commercially available from double A. The oil-proof papers were analyzed according to the standard CNS7296 to measure their oil-proof properties (e.g., Kit No. from 1 to 12). Higher Kit No. means better oil-proof properties, and Kit No. should be 7 or more to use the oil-proof paper. The oil-proof papers were analyzed according to the standard CNS7298 to measure their water absorbability (e.g., g/m²). Lower water absorbability means better property, and water absorbability should be less than 25.5 g/m² to be used as the oil-proof paper.

### Comparative Example 1

An aqueous solution of sodium carboxymethyl cellulose (Na-CMC, solid content was 10%) and potassium methylsiliconate (PMS) were mixed, in which Na-CMC and PMS had a weight ratio of 2:1. The mixture was heated to 100 to reflux and react for 1 hour, such that the hydroxy group of Na-CMC and the silanol group of PMS underwent a dehydration reaction to form a bonding, thereby obtaining PMS modified Na-CMC (hereinafter referred to as CMC-PMS-1).

Oxidized starch (i.e., starch having terminals modified by acetic acid, Dynakote 68 nbl commercially available from General Starch Limited) was added to the aqueous solution of CMC-PMS-1 and mixed to form an aqueous coating material, in which the oxidized starch and CMC-PMS-1 had a weight ratio of 50:50. The aqueous coating material was coated on the paper-based substrate, and then baked dry to form a coating layer on the paper-based substrate, thereby completing an oil-proof paper. The oil-proof paper had oil-proof properties of Kit No. 4, and the coating amount of the coating layer was 4.67 g/m². The aqueous coating material was coated on the paper-based substrate, and then baked dry to form a coating layer on the paper-based substrate, thereby completing an oil-proof paper. The oil-proof paper was dipped in water for 60 seconds to measure its water absorbability (24.6 g/m²), and the coating amount of the coating layer was 4.8 g/m². As shown above, the oil-proof paper of the coating layer containing the oxidized starch and CMC-PMS-1 had poor oil-proof properties.

### Comparative Example 2

Crosslinked starch with high molecular weight (i.e., crosslinked cationic starch, Starcat C26 commercially available from General Starch Limited) was added to the aqueous solution of CMC-PMS-1 and mixed to form an aqueous coating material, in which the crosslinked starch with high molecular weight and CMC-PMS-1 had a weight ratio of 50:50. The aqueous coating material was coated on the paper-based substrate, and then baked dry to form a coating layer on the paper-based substrate, thereby completing an oil-proof paper. The oil-proof paper had the oil-proof properties of Kit No. 5, and the coating amount of the coating layer was 3.80 g/m². The aqueous coating material was coated on the paper-based substrate, and then baked dry to form a coating layer on the paper base, thereby completing an oil-proof paper. The oil-proof paper was dipped in water for 60 seconds to measure its water absorbability (30.6 g/m²), and the coating amount of the coating layer was 4.53 g/m². As shown above, the oil-proof paper of the coating layer containing the crosslinked starch with high molecular weight and CMC-PMS-1 had poor oil-proof properties and high water absorbability.

### Example 1

Cationic starch (i.e., starch having terminals modified by ammonium ions, GELTRON 24 commercially available from General Starch Limited) was added to the aqueous solution of CMC-PMS-1 and mixed to form an aqueous coating material, in which the cationic starch and CMC-PMS-1 had a weight ratio of 50:50. The aqueous coating material was coated on the paper base, and then baked dry to form a coating layer on the paper base, thereby completing an oil-proof paper. The oil-proof paper had the oil-proof properties of Kit No. 7, and the coating amount of the coating layer was 2.55 g/m². The aqueous coating material was coated on the paper base, and then baked dry to form a coating layer on the paper base, thereby completing an oil-proof paper. The oil-proof paper was dipped in water for 60 seconds to measure its water absorbability (23.6 g/m²), and the coating amount of the coating layer was 2.55 g/m². As shown above, the oil-proof paper of the coating layer containing the cationic starch and CMC-PMS-1 had high oil-proof properties and low water absorbability.

### Comparative Example 3

An aqueous solution of Na-CMC (solid content was 5%) and PMS were mixed, in which Na-CMC and PMS had a weight ratio of 1:1. The mixture was heated to 100 to reflux and react for 1 hour, such that the hydroxy group of Na-CMC and the silanol group of PMS underwent a dehydration reaction to form a bonding, thereby obtaining PMS modified Na-CMC (hereinafter referred to as CMC-PMS-2).

Cationic starch GELTRON 24 was added to the aqueous solution of CMC-PMS-2 and mixed to form an aqueous coating material, in which the cationic starch and CMC-PMS-2 had a weight ratio of 50:50. The aqueous coating material was coated on the paper base, and then baked dry to form a coating layer on the paper base, thereby completing an oil-proof paper. The oil-proof paper had the oil-proof properties of Kit No. 6, and the coating amount of the coating layer was 2.88 g/m². The aqueous coating material was coated on the paper base, and then baked dry to form a coating layer on the paper base, thereby completing an oil-proof paper. The oil-proof paper was dipped in water for 60 seconds to measure its water absorbability (21.1 g/m²), and the coating amount of the coating layer was 2.88 g/m². As shown above, the oil-proof paper of the coating layer containing the cationic starch and CMC-PMS-2 had poor oil-proof properties.

### Example 2

An aqueous solution of Na-CMC (solid content was 5%) and PMS were mixed, in which Na-CMC and PMS had a weight ratio of 4:1. The mixture was heated to 100 to reflux and react for 1 hour, such that the hydroxy group of Na-CMC and the silanol group of PMS underwent a dehydration reaction to form a bonding, thereby obtaining PMS modified Na-CMC (hereinafter referred to as CMC-PMS-3).

Cationic starch GELTRON 24 was added to the aqueous solution of CMC-PMS-3 and mixed to form an aqueous coating material, in which the cationic starch and CMC-PMS-3 had a weight ratio of 50:50. The aqueous coating material was coated on the paper base, and then baked dry to form a coating layer on the paper base, thereby completing an oil-proof paper. The oil-proof paper had the oil-proof properties of Kit No. 8, and the coating amount of the coating layer was 4.97 g/m². The aqueous coating material was coated on the paper base, and then baked dry to form a coating layer on the paper base, thereby completing an oil-proof paper. The oil-proof paper was dipped in water for 60 seconds to measure its water absorbability (24.5 g/m²), and the coating amount of the coating layer was 1.92 g/m². As shown above, the oil-proof paper of the coating layer containing the cationic starch and CMC-PMS-3 had strong oil-proof properties and low water absorbability.

### Comparative Example 4

Cationic starch GELTRON 24 was added to the aqueous solution of CMC-PMS-1 and mixed to form an aqueous coating material, in which the cationic starch and CMC-PMS-1 had a weight ratio of 20:80. The aqueous coating material was coated on the paper base, and then baked dry to form a coating layer on the paper base, thereby completing an oil-proof paper. The oil-proof paper had the oil-proof properties of Kit No. 8, and the coating amount of the coating layer was 3.49 g/m². The aqueous coating material was coated on the paper base, and then baked dry to form a coating layer on the paper base, thereby completing an oil-proof paper. The oil-proof paper was dipped in water for 60 seconds to measure its water absorbability (31.2 g/m²), and the coating amount of the coating layer was 5.63 g/m². As shown above, the oil-proof paper of the coating layer containing an overly low amount of the cationic starch had high water absorbability.

### Comparative Example 5

Cationic starch GELTRON 24 was added to the aqueous solution of CMC-PMS-1 and mixed to form an aqueous coating material, in which the cationic starch and CMC-PMS-1 had a weight ratio of 25:75. The aqueous coating material was coated on the paper base, and then baked dry to form a coating layer on the paper base, thereby completing an oil-proof paper. The oil-proof paper had the oil-proof properties of Kit No. 8, and the coating amount of the coating layer was 5.12 g/m². The aqueous coating material was coated on the paper base, and then baked dry to form a coating layer on the paper base, thereby completing an oil-proof paper. The oil-proof paper was dipped in water for 60 seconds to measure its water absorbability (26.3 g/m²), and the coating amount of the coating layer was 4.24 g/m². As shown above, the oil-proof paper of the coating layer containing an overly low amount of the cationic starch had high water absorbability.

### Example 3

Cationic starch GELTRON 24 was added to the aqueous solution of CMC-PMS-1 and mixed to form an aqueous coating material, in which the cationic starch and CMC-PMS-1 had a weight ratio of 30:70. The aqueous coating material was coated on the paper base, and then baked dry to form a coating layer on the paper base, thereby completing an oil-proof paper. The oil-proof paper had the oil-proof properties of Kit No. 7, and the coating amount of the coating layer was 3.53 g/m². The aqueous coating material was coated on the paper base, and then baked dry to form a coating layer on the paper base, thereby completing an oil-proof paper. The oil-proof paper was dipped in water for 60 seconds to measure its water absorbability (25.2 g/m²), and the coating amount of the coating layer was 3.53 g/m². As shown above, the oil-proof paper of the coating layer containing an appropriate amount of the cationic starch had strong oil-proof properties and low water absorbability.

### Comparative Example 6

Cationic starch GELTRON 24 was added to the aqueous solution of CMC-PMS-1 and mixed to form an aqueous coating material, in which the cationic starch and CMC-PMS-1 had a weight ratio of 75:25. The aqueous coating material was coated on the paper base, and then baked dry to form a coating layer on the paper base, thereby completing an oil-proof paper. The oil-proof paper had the oil-proof properties of Kit No. 8, and the coating amount of the coating layer was 2.89 g/m². The aqueous coating material was coated on the paper base, and then baked dry to form a coating layer on the paper base, thereby completing an oil-proof paper. The oil-proof paper was dipped in water for 60 seconds to measure its water absorbability (28.1 g/m²), and the coating amount of the coating layer was 3.83 g/m². As shown above, the oil-proof paper of the coating layer containing an overly high amount of the cationic starch had high water absorbability.

### Example 4

Cationic starch GELTRON 24 and water-proofing agent alkyl keten dimer (AKD, commercially available from Solenis) were added to the aqueous solution of CMC-PMS-1 and mixed to form an aqueous coating material, in which the cationic starch and CMC-PMS-1 had a weight ratio of 50:50, and the total weight of the CMC-PMS-1 and the cationic starch and the weight of AKD had a ratio of 100:4. The aqueous coating material was coated on the paper base, and then baked dry to form a coating layer on the paper base, thereby completing an oil-proof paper. The oil-proof paper had the oil-proof properties of Kit No. 7, and the coating amount of the coating layer was 4.71 g/m². The aqueous coating material was coated on the paper base, and then baked dry to form a coating layer on the paper base, thereby completing an oil-proof paper. The oil-proof paper was dipped in water for 60 seconds to measure its water absorbability (23.3 g/m²), and the coating amount of the coating layer was 4.98 g/m². As shown above, the water-proofing agent in the coating layer could further reduce the water absorbability of the oil-proof paper.

### Example 5

Cationic starch GELTRON 24 and water-proofing agent styrene acrylate emulsion (SAE, surface sizing agent commercially available from Holdwin Trading Co., LTD.) were added to the aqueous solution of CMC-PMS-1 and mixed to form an aqueous coating material, in which the cationic starch and CMC-PMS-1 had a weight ratio of 30:70, and the total weight of the CMC-PMS-1 and the cationic starch and the weight of SAE had a ratio of 100:3. The aqueous coating material was coated on the paper base, and then baked dry to form a coating layer on the paper base, thereby completing an oil-proof paper. The oil-proof paper had the oil-proof properties of Kit No. 7, and the coating amount of the coating layer was 2.03 g/m². The aqueous coating material was coated on the paper base, and then baked dry to form a coating layer on the paper base, thereby completing an oil-proof paper. The oil-proof paper was dipped in water for 60 seconds to measure its water absorbability (23.3 g/m²), and the coating amount of the coating layer was 2.03 g/m². As shown above, the water-proofing agent in the coating layer could further reduce the water absorbability of the oil-proof paper.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A coating material, comprising:
silane salt-modified polysaccharide salt;
cationic starch; and
water.

2. The coating material as claimed in claim 1, wherein the silane salt is Si(OH)ₓ(OK)_{y}(R)_{4-x-y},
wherein R is a C₁₋₁₀ alkyl group, x=1 to 2, y=1 to 2, and x+y=2 to 3.

3. The coating material as claimed in claim 1, wherein the polysaccharide salt is a salt of cellulose derivative, natural gum, alginic acid, starch, chitosan, or a combination thereof.

4. The coating material as claimed in claim 1, wherein the polysaccharide salt and the silane salt have a weight ratio of 55:45 to 95:5.

5. The coating material as claimed in claim 1, wherein the silane salt-modified polysaccharide salt and the cationic starch have a weight ratio of 30:70 to 70:30.

6. The coating material as claimed in claim 1, further comprising a water-proofing agent, and the water-proofing agent is alkyl keten dimer, styrene acrylate emulsion, or a combination thereof.

7. The coating material as claimed in claim 6, wherein a total weight of the silane salt-modified polysaccharide salt and the cationic starch and a weight of the water-proofing agent have a ratio of 100:1 to 100:20.

8. The coating material as claimed in claim 1, wherein the coating material is free of fluorine.

9. An oil-proof paper, comprising:
a paper-based substrate; and
a coating layer covering the paper-based substrate,
wherein the coating layer comprises:
silane salt-modified polysaccharide salt; and
cationic starch.

10. The oil-proof paper as claimed in claim 9, wherein the coating layer further comprises a water-poof agent, and the water-proofing agent is alkyl keten dimer, styrene acrylate emulsion, or a combination thereof.
